(19) United States
(12) Patent Application Publication
(10) Pub. No.: US 2013/0105006 A1
(43) Pub. Date: May 2, 2013

(54) Purge box for fluorine supply

(71) Applicants: Michael Pittroff, Seoul (KR); Joon-Ki Lee, Busan City (KR)

(72) Inventors: Michael Pittroff, Seoul (KR); Joon-Ki Lee, Busan City (KR)

(73) Assignee: SOLVAY SA, Brussels (BE)

(21) Appl. No.: 13/808,397

(22) PCT Filed: Jun. 30, 2011
(86) PCT No.: PCT/EP11/61076

§ 371 Date: Jan. 4, 2013

(30) Foreign Application Priority Data
Jul. 5, 2010 (EP) 10168436.3

(51) Int. Cl. F17D 1/00

(52) U.S. Cl. CPC F17D 1/00
USPC 137/343

(57) ABSTRACT

A purge system built with a purge box, pipes, valves, and a manifold panel. Apart from ventilation systems in ordinary gas cabinets, it is characterized by minimizing hazards through safe exhaust of toxic and reactive gases and through prevention of explosion and fire with complete cutoff of air (oxygen, in particular) in case of contamination and leakage arising in such pipes, valves and manifold panel involved in purging inert gases (Ar and N₂). The purge box can preferably block external air from a joint area connecting gas pipes and a gas container, such as a cylinder, which is prone to leakage and contamination due to frequent attachments and detachments. In addition, a supply valve of the hazardous reactive chemical is closed, to avoid further releases. Physical and chemical damages resulting from attaching and detaching a cylinder mounted on a gas supply facility including existing or separate gas cabinets can be prevented.

### CROSS-REFERENCE TO RELATED APPLICATIONS

This application is a U.S. national stage entry under 35 U.S.C. §371 of International Application No. PCT/EP2011/061076 filed Jun. 30, 2011, which claims priority benefit to European Patent Application No. 10168436.3 filed on Jul. 5, 2010, the whole content of this application being incorporated herein by reference for all purposes.

### TECHNICAL FIELD OF THE INVENTION

The present invention pertains to purge systems, and more particularly to a purge system that can prevent hazardous elements including gas leakage around special gas supply facilities used in a cutting-edge industry such as semiconductors, photovoltaic and liquid crystal display (LCD) devices.

### BACKGROUND OF THE INVENTION

Managing special gases, which are one of the most essential reactive chemicals in semiconductor, photovoltaic and LCD factories, is extremely important. In this regard, diverse gas cabinets and gas supply facilities are used. Most of the special gases are extremely hazardous due to corrosive behavior, toxicity, flammability and ignitability. As such, they must be handled with extreme care.

Conventional gas supply facilities adopt simple exhaust systems in a way that the cylinder and the entire panel are placed in one cabinet. By doing so, external air can be introduced into the whole system and the pressure may then be reduced to emit gases through an exhaust duct. Specifically, gases, which are highly reactive, explosive and spontaneously combustive, can cause damage, explosion and fire as a result of gas leakage. Further, such gases can lead to a significant loss of time and money as facility stop and restart are unavoidable. In addition, since they are built in one cabinet, they cannot completely eliminate hazardous elements in substantially hazardous locations.

### SUMMARY OF THE INVENTION

The purpose of this invention, especially of the purge box of the present invention, is to shut off the joint between a gas pipe and a cylinder from external/ambient air, which is a major cause of contamination, combustion and fire due to leakage of special gases used for semiconductors. The present invention seeks to provide a separate safety connecting box that purges and exhausts inert gases (Ar or N₂ etc).

To achieve the above, the purge box according to the present invention comprises: a pipe for supplying a purge gas; a pipe for venting the purge gas; valves connected to the pipes for supplying and venting the purge gas; inlets through which pipes from a container containing a reactive chemical and from a supply system pass through and are connected to the purge box by a joint; and a casing surrounding the pipes, valves and inlets. The sensor of the gas leakage detector is as well in this purge box.

### BRIEF DESCRIPTION OF THE DRAWINGS

FIG. 1 is a schematic view of a purge box configuration constructed according to the present invention.

FIG. 2 is a detailed view of the purge box according to the present invention.

FIG. 3 is a schematic view of a purge system constructed according to the present invention.

FIG. 4 is a schematic view of a casing for the purge box according to the present invention.

### DETAILED DESCRIPTION

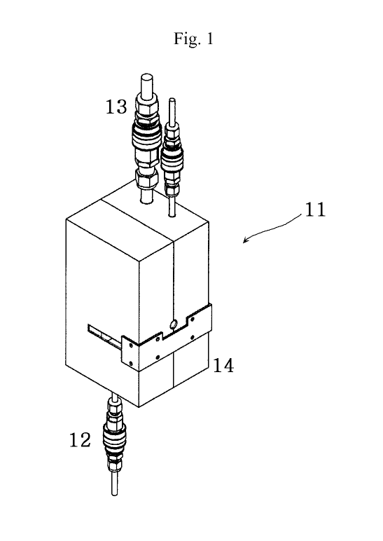

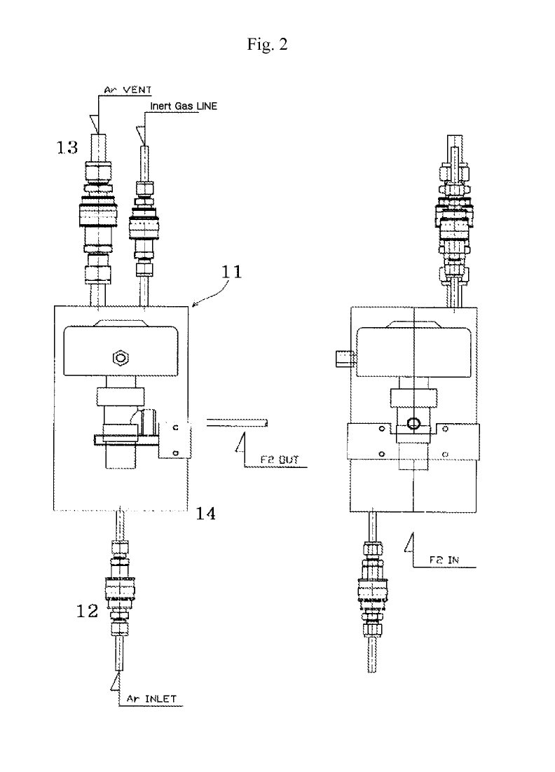

The purge box, which is illustrated in FIGS. 1 and 2, is a tool used to avoid releases of hazardous gases such as elemental fluorine to the atmosphere. Further, this box can be flushed with inert gas to dilute the released F₂ in the box. This is particularly important when working with F₂ of almost 100% purity in order to avoid F₂ burns in the gas supply system.

Often, F₂ is supplied to the point of use by means of a bundle of hollow bodies, such as containers, e.g. containers of elongated cylindrical geometry, comprising the F₂ or gas mixtures containing F₂. A bundle trailer which is well suited for the delivery of F₂ gas or F₂ gas containing mixtures is described in international patent application WO 2010/046428. The bundle trailer often includes several bundles, e.g. six bundles, and each bundle includes several containers, e.g., from 2 to 40 of them, for the storage of F₂ or F₂ containing mixtures. Each bundle is connected via a bundle valve. Each bundle valve is connected to a main pipe which is connected with a trailer valve. The trailer valve is connected with a pipe for delivery of the F₂ to a local gas supply system. When the F₂ stored in the bundle trailer is almost completely delivered, the spent bundle trailer must be substituted by a fresh bundle trailer. The trailer valve and the bundle valves are closed, and the pipes are disconnected.

The purge box can be used at the connection between the bundle and the local gas supply system.

Leakage most likely occurs at the connection between a bundle and the gas supply system; this connection is often subjected to frequent attachments and detachments. If such a leak occurs, then a gas monitor will immediately recognize the gas release and send a signal to the bundle valve to close the supply and simultaneously signal the gas cabinet valve to supply inert gas. Immediately, the gas safety box is flushed with inert gas to avoid higher concentrations of, for example, F₂ of 100% gas, to avoid ignition of F₂. The inert gas and the leaked gas will go to the POU (Point Of Use) scrubber of the system. Although any scrubber that can efficiently decompose the leaked gas can be used, it is preferable to use scrubber systems that include alkaline aqueous solutions such as calcium hydroxide or solid scrubber calcium carbonate. Simultaneously with increasing the purge flow of inert gas, the valve for F₂ supply will be closed, so that after 30 seconds no F₂ will be released.

As the purge box wraps the joint between the cylinder and the pipe, it prevents a second hazardous accident from occurring around the joint between the cylinder and the gas pipe due to frequent attachment and detachment, which can lead to contamination and leakage.

In one embodiment, the reactive chemical is elemental fluorine. In another embodiment, the purge gas is at least one of the inert gases, preferably argon, or nitrogen.

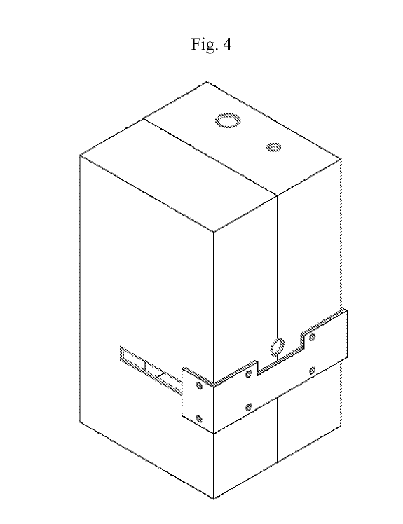

In other embodiments, the casing is generally box-shaped as shown in FIG. 4. In the preferred embodiments, the casing is configured so that external air cannot penetrate into the casing. In another embodiment, the purge box comprises a detector for monitoring the reactive chemical. The casing is at least partially fabricated from stainless steel such as those per ASTM A240 Type 304, although other materials that are inert to fluorine can also be used.

The present invention is further directed to a purge system, comprising: at least one container for containing a reactive chemical and preferably having a cylindrical shape; the purge box as defined above; a manifold panel comprising pipes and valves for controlling flows of the reactive chemical and purge gases; and a detector for monitoring the reactive chemical. In the preferred embodiments, the purge system further comprises a scrubber connected to the pipe for venting the purge gas and the detector sets off an alarm as soon as a leakage of the reactive chemical occurs.

In the specific embodiments of the present invention, the purge system comprises: a casing surrounding the purge box; at least one container for a reactive chemical; a manifold panel comprising pipes and valves for controlling flows of reactive chemical and purge gases; and a detector for monitoring the reactive chemical.

The present invention is also directed to a use of the purge box in special gas supply facilities utilized in a semiconductor, photovoltaic or liquid crystal display (LCD) industry or micro-electromechanical systems (MEMS) industry, particularly to prevent hazards caused by leaking reactive chemicals and/or burning due to concentrated chemicals.

The present invention is not limited to the uses and applications mentioned above. It is possible for anyone who has a general knowledge of the related art to modify the uses and applications as needed.

Referring to the accompanying drawings, examples of ideal applications are described herein.

FIGS. 1 and 2 schematically illustrate an embodiment of the purge box configuration constructed according to the present invention. The purge box (11) comprises: a pipe (12) for supplying a purge gas; a pipe (13) for venting the purge gas; valves are located outside of the casing connected to the pipes for supplying and venting the purge gas (not shown); inlets through which pipes from a container containing fluorine gas and from a supply system pass through and are connected to the purge box by a joint; and a casing (14) surrounding the pipes, valves and inlets.

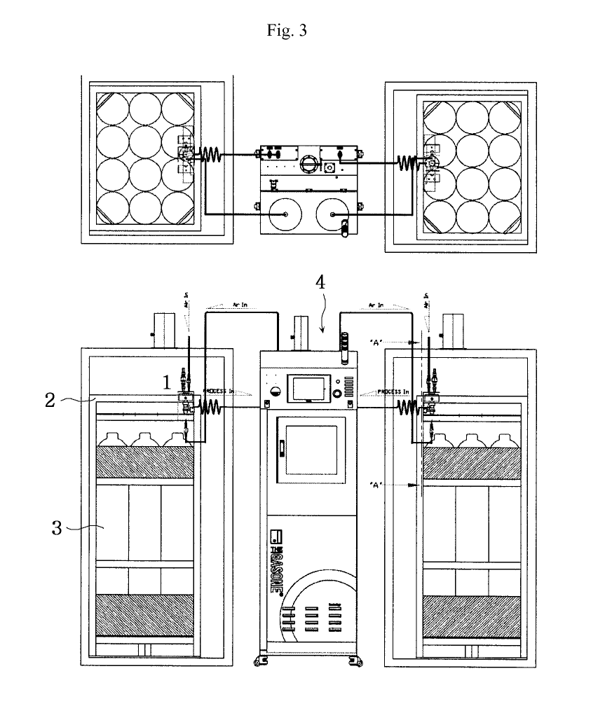

FIG. 3 schematically illustrates an embodiment of a purge system according to the invention. The purge box (1) of the present invention is set on a bundle frame (2) on which a plurality of containers (3) containing a chemical is mounted. The purge box (1) is welded together by two parts for an easier assembly. A manifold panel (4) of the purge system comprises: pipes and valves for controlling flows of the reactive chemical from the containers and purge gases; and a detector for monitoring the reactive chemical. If a reactive gas is leaked, e.g., when connecting a bundle to the gas supply system, then a detector will immediately recognize the gas leak and give a signal to the bundle valve to close the supply of the reactive gas, while almost simultaneously, the purge box is flushed with argon gas to avoid increasing concentrations of, for example, more than F₂ 20% gas, and the consequences thereof The purge gas will immediately flush the purge box as soon as F₂ is detected. The high flow rate of the purge gas will avoid the increase of F₂ concentration and prevent a critical concentration for start burning. Besides the dilution effect, there is also a cooling effect, which can be considered. In addition to this the F₂ supply valve will be closed at the same time.

The purge system further comprises a scrubber connected to the pipe for venting the purge gas. Further, the detector sets off an alarm as soon as a leakage of the reactive chemical occurs. The inert gas (e.g., argon) containing leaked fluorine is carried to the POU (Point Of Use) scrubber which is either a dry or wet scrubber system. The flushing with the inert gas such as argon is performed until the bundle valve is closed and no F₂ signal above the Threshold Limit Value (TLV) value is detected. In the next step, the safety box can be opened and the connection and gasket can be exchanged and/or readjusted. The specific configurations of bundle systems are described in PCT Application No. PCT/EP2009/063867 (published as WO 2010/046428), which is incorporated herein by reference in their entirety.

Due to the purge box of the present invention, in case the gas leaks in the joint between the cylinder and the pipe, inert gases (e.g., argon, nitrogen, etc.) are purged and external air is shut off by the box-shaped structure to prevent hazards caused by contamination, combustion, explosion and fire, as well as to exhaust the leaked special gases and wastes. This can secure the continuity of facility operation and prevent any unnecessary accidents. Physical and chemical damages resulting from attaching and detaching the cylinder mounted on the gas supply facility including existing or the separate gas cabinets can be prevented.

Should the disclosure of any patents, patent applications, and publications which are incorporated herein by reference conflict with the description of the present application to the extent that it may render a term unclear, the present description shall take precedence.

1. A purge box, comprising:
a pipe for supplying a purge gas;
a pipe for venting the purge gas;
valves connected to said pipes for supplying and venting the purge gas;
inlets through which different pipes from a container containing a reactive chemical and from a supply system pass through and are connected to the purge box by a joint; and
a casing surrounding said pipes for supplying and venting the purge gas, valves and inlets.

2. The purge box according to claim 1, wherein the reactive chemical is elemental fluorine.

3. The purge box according to claim 1, wherein the purge gas is at least one of inert gases.

4. The purge box according to claim 3, wherein the purge gas is argon.

5. The purge box according to claim 3, wherein the purge gas is nitrogen.

6. The purge box according to claim 1, wherein the casing is generally box-shaped.

7. The purge box according to claim 1, wherein the casing is configured so that an external air cannot penetrate into the casing.

8. The purge box according to claim 1, wherein the casing surrounds a connection between a bundle of containers containing the reactive chemical and a local gas supply system.

9. The purge box according to claim 1, further comprising a detector for monitoring the reactive chemical.

10. A purge system, comprising:
at least one container for containing a reactive chemical;
the purge box according to claim 1;
a manifold panel comprising pipes and valves for controlling flows of the reactive chemical and purge gases; and
a detector for monitoring the reactive chemical.

11. The purge system according to claim 10, further comprising a scrubber connected to said pipe for venting the purge gas.

12. The purge system according to claim 10, wherein the container has a generally cylindrical shape.

13. The purge system according to claim 10, wherein the detector sets off an alarm as soon as a leakage of the reactive chemical occurs.

14. The purge system according to claim 10, comprising a casing surrounding the purge box, said at least one container for a reactive chemical, said manifold panel comprising pipes and valves for controlling flows of the reactive chemical and purge gases, and said detector for monitoring the reactive chemical.

15. A method in special gas supply facilities utilized in a semiconductor, photovoltaic, MEMS or LCD industry, comprising using the purge box according to claim 1.

16. The method according to claim 15, being for the prevention of hazards caused by leaking reactive chemicals and/or burning due to concentrated chemicals.
